(19) United States
(12) Patent Application Publication
(10) Pub. No.: US 2023/0160388 A9
(43) Pub. Date: May 25, 2023

(54) Water Heating System and Valving for These

(71) Applicant: Rheem Australia Pty Limited, Rydalmere (AU)

(72) Inventor: Josh Cooper, Rydalmere (AU)

(21) Appl. No.: 16/866,831

(22) Filed: May 5, 2020

Related U.S. Application Data
(62) Division of application No. 15/863,475, filed on Jan. 5, 2018, now abandoned.
Application No. 15/863,475 is a continuation of application No. PCT/AU2016/050591, filed on Jul. 7, 2016.

(30) Foreign Application Priority Data
Jul. 10, 2015 (AU) 2015902733

(51) Int. Cl. F04D 13/12; F04D 15/02; F04D 15/00; F24D 19/10; F24D 17/00

(52) U.S. Cl. CPC F04D 13/12; F04D 15/0245; F04D 15/0263; F04D 15/029; F04D 15/0016; F24D 19/1057; F24D 17/0068; Y02B 10/70; Y02B 10/20; F28F 2265/00; F28F 2265/10; F24D 2220/08; F24D 2220/06; F24D 2200/14; F24D 2200/08; F24D 2200/04; F28D 20/0034

(57) ABSTRACT

The disclosed technology relates to a solar water heating system including a tank configured to store heat transfer fluid, a solar collector in fluid communication with the tank, and a pump system in fluid communication with the tank and the solar collector. The pump system can include a first pump, a second pump, and a valve assembly. The valve assembly can direct the heat transfer fluid from an outlet of the first pump to the solar collector when the first pump is operating and can direct the heat transfer fluid from an outlet of the second pump to the solar collector when the second pump is operating. The first pump and the second pump can transfer the heat transfer fluid from the solar collector back to the tank when the first pump and the second pump are not operating.

### FIELD OF THE INVENTION

The present invention relates to freshwater stations or district water heating systems, and in particular in improvements to the primary circuit and the secondary circuit of such systems. More particularly the present invention can be used with solar water heating systems, electric boosted solar systems, gas boosted solar systems, cogeneration systems and hybrid systems.

### BACKGROUND OF THE INVENTION

Solar thermal water heating systems with solar panels are subject to temperature and duty cycle events which threaten the integrity of the collector or its pipes. In the case of freezing temperatures and ice formation, or over-temperature situations where continuing to heat the working fluid at the collector when there is solar energy absorbed but which can no longer be dissipated within the system, resulting in the super heating of the working fluid, both situations can cause pressurising of the system. In either of these circumstances, one solution is to drain the solar collector of working fluid and store it in a reservoir for pumping back to the collector or collectors when needed. These are known as drain-back systems.

In commercial applications duty standby pumps are often used for pump skids. When one pump is in operation the other pump is switched off. In order to prevent flow from being “short circuited” from one pump to the other, one way valves are installed at the exit of each of the individual pumps. “Short circuiting” can occur because the type of pump used is usually a non-positive displacement type, therefore permitting fluid to flow through the pump body even when the impeller is not in operation. Such systems are not able to use a drain back feature in solar applications, because the installation of one way valves in the circuit makes backward flow not possible.

Water heating systems that utilise a heat exchanger to separate the working fluid such as solar or cogeneration systems traditionally control the outlet temperature on the potable water side via a form of thermostatic mixing valve. The thermostatic mixing valve blends hot and cold water to produce the desired temperature. The valve can be either electronically controlled or via a thermostatic element. When such a valve is used there is an inherent increase in pressure drop across the valve caused by the pump in the circuit when the valve closes to restrict the flow of hot water. This increase in pressure drop effectively means the pump is continuing to draw maximum power even in times where there is little or no load on the system.

A second disadvantage of a valve based system is that, due to the large pressure drop across the valve, large pumps and their associated high cost and power requirements are a necessity.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention provides a pump system for use with a solar collector system which is used to heat a heat transfer fluid, the solar collector system including a storage tank for the heat transfer fluid used in the solar collector system, the pump system having a first and second pump arranged in parallel which can pump the heat transfer fluid from the storage tank to a solar collector, so that should one pump fail the other pump can function, wherein the outlet of the first pump and the outlet of the second pump are connected to a valve arrangement, whereby when the first pump operates, the outlet of the second pump is substantially closed by the flow from the first pump and when the second pump operates, the outlet of the first pump is substantially closed by the flow from the second pump.

The valve arrangement can have three ports and a valve member which effectively closes a first pump's outlet port when a second pump is operating and the first pump is not, and closes the second pump's outlet port when a first pump is operating and the second pump is not operating.

The valve arrangement can have a flap which closes the first pump's outlet port and moves to a second location when activated by the first pump to close the second pump's outlet port.

The outlet ports can be located on respective pipes which connect to the pumps.

The pump system can be provided as part of a skid.

The present invention also provides a solar water heating system having a pump system described above wherein the heat transfer fluid is not potable water.

The present invention also provides a solar water heating system having a pump system described above wherein the heat transfer fluid is potable water.

The present invention further provides a valve for a pump system having two pumps and which will allow drain back of a pumped fluid, the valve including a body having first and second ports for respectively connecting to respective pump outlets or conduits from the outlets, and a third port, whereby when a pump is pumping the third port is an outlet from the body, and when the pumps are not pumping, the third port is an inlet to the body.

Between the first and second ports is located a valve member which can move so as to close off one of the first or second ports depending upon which pump is operating.

The valve member can be a flap.

The flap can be connected by a hinge means to the body which allows movement of the flap between the first and the second ports.

The valve member closes off the first or second ports to a substantial extent, that is watertight sealing is not required by the valve.

The flap can be manufactured from a metal, a polymeric material or a composite material.

Valve seats surrounding the first and second ports can be manufactured from a metal, a polymeric or a composite material.

Surrounding the first port or the second port or the third port is one of the following: a male thread, a female thread.

Surrounding a respective port is a female thread.

The flap can be held rotatable in the body, or pivotally held in the body, by means of opposed pins which seal to the body and pass into the body.

The present invention also provides a water heating system having a primary circuit to supply a heated heat transfer fluid to a heat exchanger, which supplies heat to a secondary circuit having potable water therein, wherein the primary circuit includes at least one pump to circulate the heat transfer fluid through the heat exchanger, and a control system to control the operation and output flow rate of at least one pump, characterized in that the control system measures the temperature, or an indication of the temperature of the potable water after it has left the heat exchanger, so as to control the output flow rate of the at least one pump.

The primary circuit can heat the heat transfer fluid by one of or a combination of more than one of the following: solar; gas, electric, cogeneration means; gas boosted solar; electric boosted solar.

The secondary circuit can have or be one or more of the following: is a freshwater station system; is a district water heating system; a pump; a filter; a cold water supply; an over temperature shut down mechanism.

The water heating system can be such that the heat exchanger is provided in a delivery skid whereby there are two heat exchangers present on the skid, with respective isolation valves and having parallel connections to an incoming conduit and an outgoing conduit, whereby one of said heat exchangers is present in a redundancy capacity.

The system can have multiple skids connected to each other to provide the heat exchanger of the system.

The present invention also provides a heat exchanger apparatus comprising a frame to support at least two heat exchangers, between an inlet conduit and an outlet conduit, wherein the at least two heat exchangers having connection to the inlet and outlet conduit in parallel, the connection being via isolation valves and forming a liquid supply inlet and heated liquid outlet, and each heat exchanger having fluid connection, via isolation valves, to a primary circuit to receive a heat transfer fluid to transfer heat to the liquid, characterized in that at least one of the heat exchangers is present in a redundant capacity.

The inlet conduit and the outlet conduit have flanged ends to allow connection to an adjacent like heat exchanger apparatus, and or a conduit closure.

### BRIEF DESCRIPTION OF THE DRAWINGS

A detailed description of a preferred embodiment will follow, by way of example only, with reference to the accompanying figures of the drawings, in which:

FIG. 1 illustrates a schematic view of a solar water heating system with primary and secondary circuits, the primary circuit deriving heat exclusively mainly from solar but is also provided with an electric booster;

FIG. 2 illustrate a schematic view of a water heating system similar to that of FIG. 1, except that the system includes a direct gas booster in the form of a gas boost on the secondary circuit;

FIG. 3 illustrate a schematic view of a water heating system similar to that of FIG. 1, except that the system includes an indirect booster in the form of a gas boost on the primary circuit;

FIG. 4 illustrate a schematic view of a water heating system similar to that of FIG. 1, except that the system is a hybrid system and includes dual indirect boosters in the form of a gas boost and an electric boost on the primary circuit;

FIG. 5 illustrate a schematic view of a water heating system, except that the system includes co-generation unit and chiller in the primary circuit;

FIG. 6 illustrates a perspective view of a flap valve body;

FIG. 7 illustrates a cross section through the valve of FIG. 6;

FIG. 8 illustrates a front view of the valve of FIG. 6;

FIG. 9 illustrates an end view of the valve of FIG. 6;

FIG. 10 illustrates an alternative valve arrangement in the form of a ball valve showing operating condition with one pump on;

FIG. 11 illustrates the valve arrangement of FIG. 10, where both pumps are off in a first operating condition;

FIG. 12 illustrates the valve arrangement of FIG. 10, where both pumps are off in a second operating condition

FIG. 13 illustrates another ball valve arrangement showing condition with one pump on;

FIG. 14 illustrates the valve arrangement of FIG. 13 where both pumps are off;

FIG. 15 is a front view of a delivery skid;

FIG. 16 is a side view of the delivery skid of FIG. 15;

FIG. 17 illustrates dual delivery skids assembled in parallel for use in the systems of FIGS. 1 to 5.

### DETAILED DESCRIPTION OF THE EMBODIMENT OR EMBODIMENTS

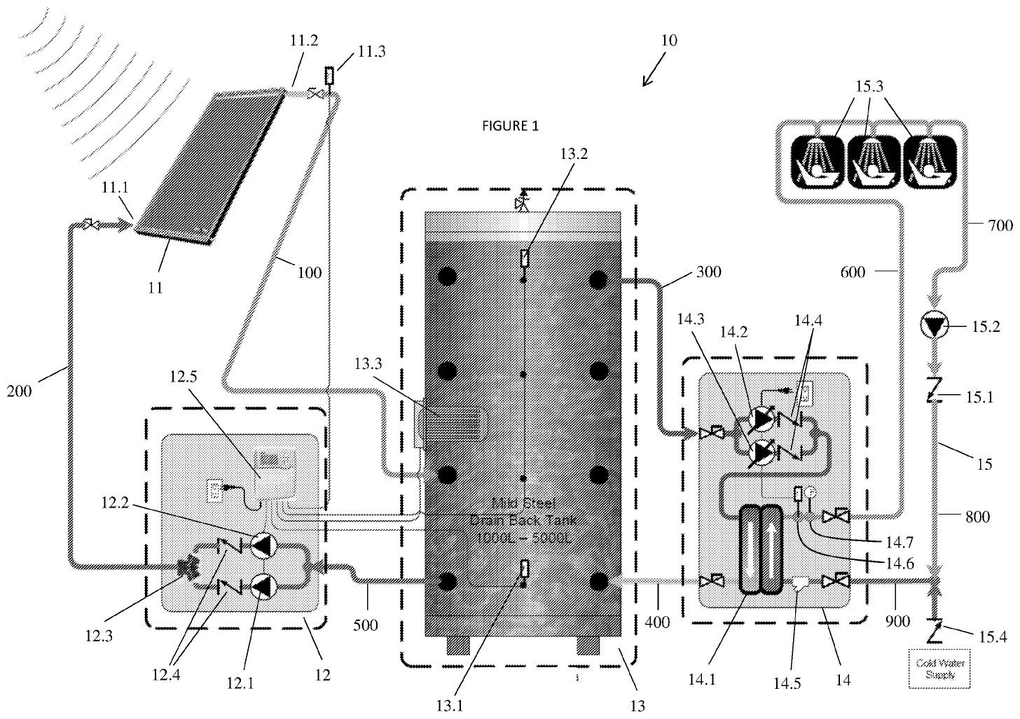

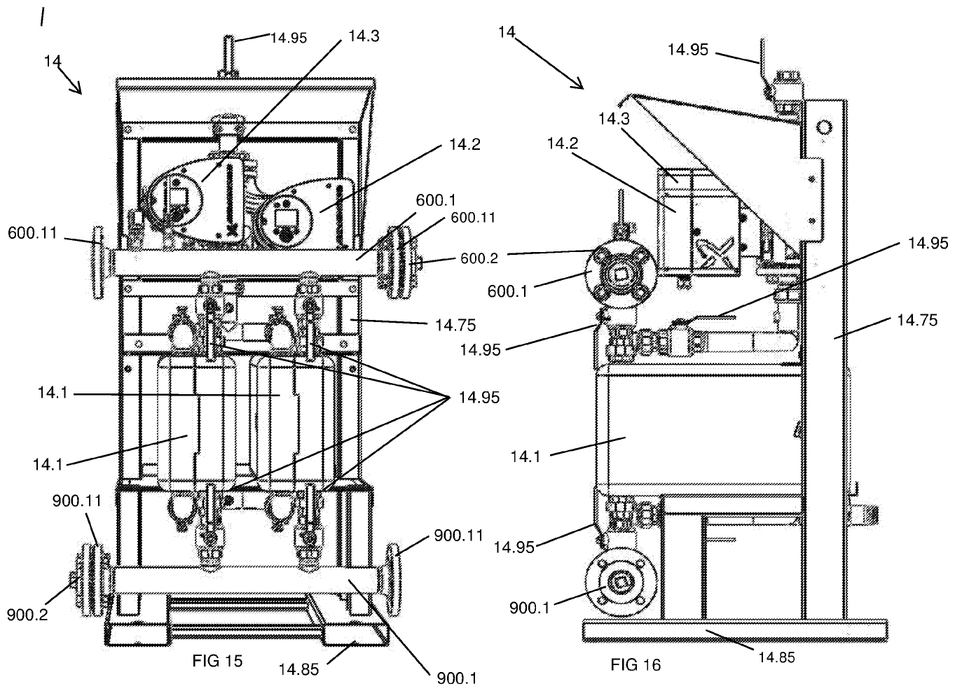

Illustrated in FIG. 1 is a schematic of a solar water heating system 10 which comprises a primary circuit made up of a solar collector 11 (only one illustrated for ease of illustration—whereas a gang or bank of such collectors is normally used), a solar pump skid 12, heat transfer fluid tank 13 which serves as a drain back tank, and a delivery skid 14 (which includes a heat exchanger 14.1-only one illustrated for ease of illustration—whereas a gang or bank 2 or more of such skids 14 can be used as described below in respect to FIGS. 15 to 17), and a potable hot water delivery circuit or secondary circuit 15, which are all plumbed and connected together as described below.

The solar collection panel or collector 11 has an entry port 11.1 in its base and an exit port 11.2 at its top so that heated transfer fluid can exit the collector and via conduit 100 transfers to or makes it way to the drain back tank 13. The collector 11 includes a temperature sensor 11.3 which has its signals delivered to the controller 12.5 on the solar pump skid 12.

Delivering heat transfer fluid from the tank 13 to the collector 11 is the function of the pump skid 12, which has a first pump 12.1 and a second pump 12.2, which are of the non-displacement type such as an impeller type pump. The type of pump selected must be of the sort that will allow fluid to flow from the conduit 200 to the conduit 500 and back to the tank 13, if the pumps 12.1 and 12.2 are not operating. This type of pump is needed to ensure that the system 10 allows for the drain back of the heat transfer fluid from the collector 11 via conduit 200 back through pump 12.1 and or 12.2 and then back to the tank 13.

The conduit 500 draws heat transfer fluid from the tank 13 from a lower location thereon as the cooler heat transfer fluid is available from such a lower location. Whereas, the heated transfer fluid exiting the collector 11 via outlet 11.2 enters the tank 13 at an intermediate height thereon, with the heated heat transfer fluid being drawn off via conduit 300 from the top of the tank 13 for conveying to the inlet of the delivery skid 14. Whereas the conduit 400 returns the cooled heat transfer fluid which exits the heat exchanger 14.1 and conveys it back to the base of the tank 13, where it can be re-delivered to the collector 11 via conduit 500, pump skid 12 and conduit 200.

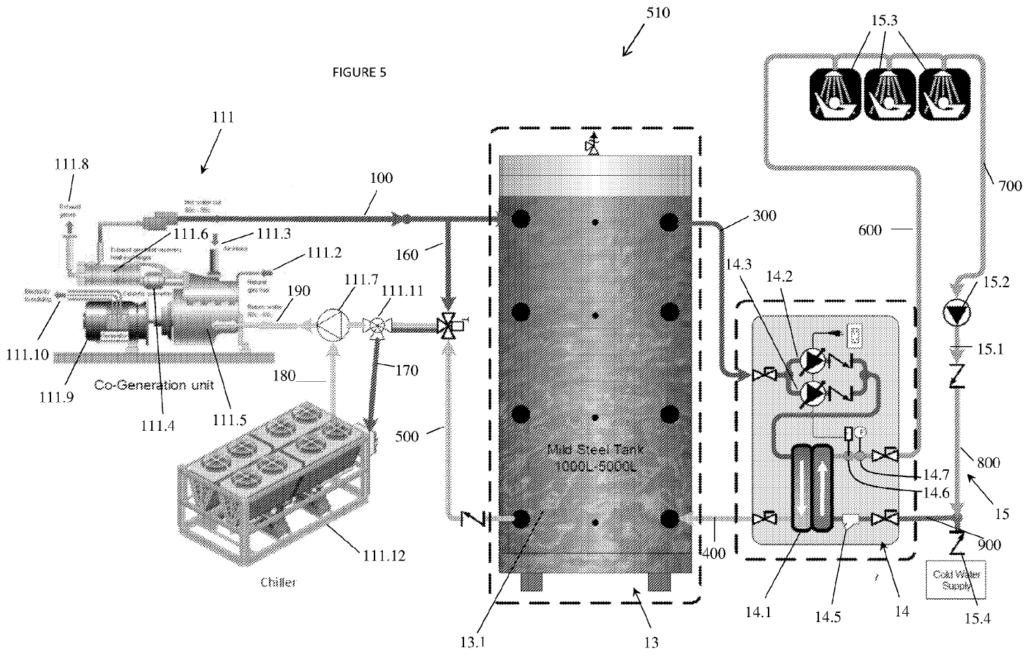

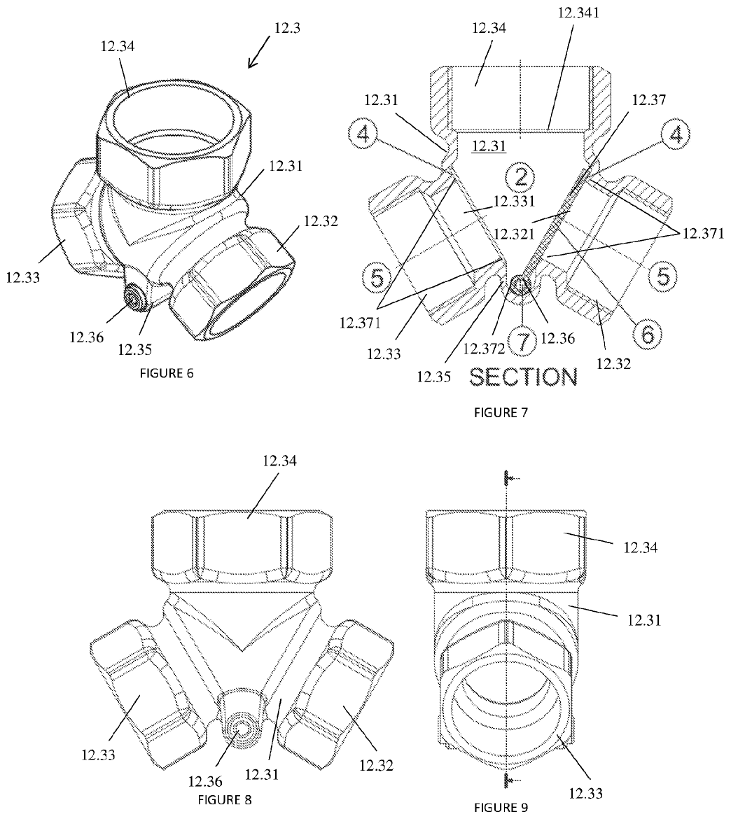

The pump skid 12 has the parallel plumbed pumps 12.1 and 12.2 powered from the control unit 12.5. The outlets of the pumps 12.1 and 12.2 connect to the inlet ports on either side of a flap of a flap valve 12.3, with the outlet of the valve 12.3 connecting to the inlet of conduit 200. The construction of the valve 12.3 will be described in more detail below with respect to FIGS. 6 to 10.

The pumps 12.1 and 12.2 are assembled with appropriate conduits each so as to be in parallel, so that should one pump fail, the other pump can be operated. With suitable isolation valves, not illustrated, this will allow the replacement of the non-operating pump while the other pump is operating.

In addition, the valve 12.3 is structured such that when the first pump 12.1 is operating, while the outlet of the first pump 12.1 and the outlet of said second pump 12.2 are connected to the valve 12.3, then when the first pump 12.1 operates the outlet of the second pump 12.2 is substantially closed due to the flow from the first pump 12.1 acting against the flap of the flap valve 12.3. Then and when the second pump 12.2 operates- and pump 12.1 is not, the outlet of the first pump 12.1 is substantially closed by the flow from the second pump 12.2 acting against the flap of the flap valve 12.3.

The valve 12.3 is arranged so that valve member or flap 12.37 of valve 12.3 effectively closes a first pump 12.1 outlet port when the second pump 12.2 is operating and the first pump 12.1 is not, and closes the second pump 12.2 outlet port when the first pump 12.1 is operating and the second pump 12.2 is not operating.

The valve 12.3 as illustrated in FIGS. 6 to 10 comprises a valve body 12.31 of brass or brass alloy (or any appropriate material), and in which is formed two ports 12.331 and 12.321 each respectively surrounded by a sealing rim 12.371 which when heat transfer fluid flows into the body act as inlets to the valve 12.3. The two ports 12.331 and 12.321 feed to the third port 12.341 which acts as an outlet when heat transfer fluid flows out of the valve body and as an inlet when heat transfer fluid flows into the valve body in a drain back condition.

It can be seen that the longitudinal axes 5 (normal to the plane of the ports 12.331 and 12.321) are at 60 degrees to each other. This ensures that the pivoting or rotating flap 12.37 only rotates through 60 degrees from closing one port to closing the other port. The angle between the longitudinal axes 5, being at 60 degrees, is not essential for the action and or function of the flap 12.37. This measurement was selected so that the angled valve seats 12.371 can be readily machined through the ports 12.331 and 12.321. The ports 12.331 and 12.321 could have been located 180 degrees apart and the valve will function effectively

The flap 12.37 is made of stainless steel, and it will be noted that none of the flap 12.37 or the seats or sealing rims 12.371 include any polymeric linings, mouldings or seats, and this makes the valve 12.3 robust and relatively cheap to manufacturer which will give a good service life with little to no maintenance and very little risk of failure. While such mouldings are not necessary as a leak tight seal is not required, this is not to say they couldn't be added if desired or required.

The flap 12.37 is of a circular configuration with a pivot tube 12.372 at its base, which pivot tube 12.372 will sit in the part cylindrical sub housing 12.35 at the base of the valve body 12.31. The opposite ends of the pivot tube 12.372 on the flap 12.37 pivotally or rotatably hold the flap 12.37 in the body 12.31 by interaction with opposed inwardly extending pivot pins on the ends of machine screws 12.36. The heads of the respective machine screws 12.36 have a sealing washer (not illustrated) between the head and the sub housing 12.35 so that no leakage occurs in use.

The ports 12.321, 12.331 and 12.341 are each surrounded by female threaded hexagonal formation 12.32, 12.33 and 12.34, so that they can respectively connect to the outlets of the pumps 12.1 and 12.2 and the inlet to conduit 200. While a female threaded connection is illustrated, it will be readily understood that any appropriate connection mechanism can be utilised, including, amongst others, push fit connections, slip joints, O-ring connections, male threaded connections, grooved coupling and grooved fittings such as those available under the Victualic brand, and any appropriate fitting mechanism.

The opposed side surfaces of the stainless steel flap 12.37 makes contact with the brass or brass alloy seats 12.371 to close the respective port of the other pump when a pump is running, however a perfect seal is not required, and as such no sealing components or polymeric seats are used. While specific materials such as stainless steel for flap 12.37 and brass or brass alloy for the valve body 12.31 and seats 12.371 are mentioned it will be understood that any appropriate material for such components can be used including other metals, polymeric materials or composite materials.

The valve 12.3 while one of the pumps 12.1 or 12.2 is operating closes a return path for fluid which would otherwise go through the non-operating pump. However the valve 12.3 also allows, when both pumps are not operating, the ability for heat transfer fluid to drain back from the inlet 11.1 of the collector 11 back through the valve 12.3 and through the pump 12.1 or 12.6 depending on which side the flap 12.37 was resting against. So when one of the pumps is working its associated port in valve body 12.31 is an inlet, and the other pumps port is an outlet which is closed off by the flap, and the third port which connects to the conduit 200, is an outlet from the valve when a pump is operating, but is an inlet to the valve when the pumps are off.

In the FIGS. 1 to 4 there is illustrated check valves 12.4 located between the outlet of the pumps 12.1 and 12.2 and the valve 12.3. However, this is for representation purposes only, because from the previous description it will be understood that the operation of one pump such as 12.1 ensures that the pumped flow, will not head towards the other pump, such as 12.2, because the pressure from pump 12.1 pushes the flap 12.37 against the seat 12.371 on the inlet/outlet which leads to or form the pump 12.2. With the opposite occurring when the pump 12.2 is operated and the pump 12.1 is not.

It will be noted that the controller 12.5 in addition to receiving a signal from temperature sensor 11.3 also receives temperature signals from sensors 13.1 at the bottom of the tank 13 and sensor 13.2 at the top of the tank 13. Depending upon the temperatures available at the top sensor 13.2 the controller 12.5 can activate the electric element 13.3 to boost the temperature of the heat transfer fluid in the tank 13.

The heat transfer fluid in the system described above can be any appropriate heat transfer fluid which includes non-potable water or such like based liquids. However it will be understood that the heat transfer fluid could also be potable water.

As illustrated in FIG. 1 the delivery skid 14 as mentioned above includes a heat exchanger 14.1, which receives heated transfer fluid from the tank 13 in the primary circuit for the purpose of heating potable water in the heat exchanger 14.1 for the secondary circuit 15. The delivery skid 14 also includes two pumps 14.2 and 14.3 (the second pump being available in case of failure of the first pump- or to share the load in an intermittent use modality) and two respective check valves 14.4, which in this instance, unlike valves 12.4, serve a check valve purpose. Heat transfer fluid transfers from tank 13 via conduit 300 and exits the heat exchanger 14.1 and the delivery skid 14 back to the tank 13 via the conduit 14.

On the secondary circuit side in the delivery skid 14, the conduit 600 carries heated potable water from the delivery skid 14 to the end users in this case represented by showering people icons 15.3. The secondary circuit 15 includes a return conduit 700, a pump 15.2 and non-return valve 15.1 and conduit 800. At the end of conduit 800 the conduit 800 enters a junction, a branch of which has incoming cold water supply via a one way valve 15.4, and the other branch being conduit 900 to take back cold water and return heated water to the heat exchanger 14.1 to be re-heated. Preferably in the delivery skid 14 there is also located an inline filter 14.5.

An important feature of the delivery skid 14 is that the control system which operates the heat exchange fluid passing through the heat exchanger 14.1 measures the temperature at the outlet of the heat exchanger of the potable water circuit 15 by temperature sensor and sender 14.6, which is adjacent to an over temperature cut out 14.7. In response to the temperature measured at sensor 14.6 the flow rate out of the pump 14.2 or 14.3 is increased so as to increase the temperature of the water at 14.6 or the flow rate is decreased to decrease the temperature at the sensor 14.6. If the temperature cut out 14.7 is activated the pumps 14.2 and Or 14.3 can be switched off. Prior art systems would otherwise use cold water mixing to obtain the desired output potable water temperature.

Thus on the secondary side and the interface between the primary and secondary sides, the water heating system 10 has a primary circuit to supply a heated heat transfer fluid to the heat exchanger 14.1, which supplies heat to a secondary circuit 15 having potable water therein, wherein the primary circuit includes at least one pump 14.2 or 14.3 to circulate the heat transfer fluid to and through the heat exchanger 14.1, and a control system to control the operation and output flow rate of at least one pump 14.2 or 14.3, whereby the control system measures the temperature, or an indication of the temperature of said potable water after it has left the heat exchanger 14.1 at location of sensor 14.6, so as to control the output flow rate of the at least one pump 14.2 or 14.3.

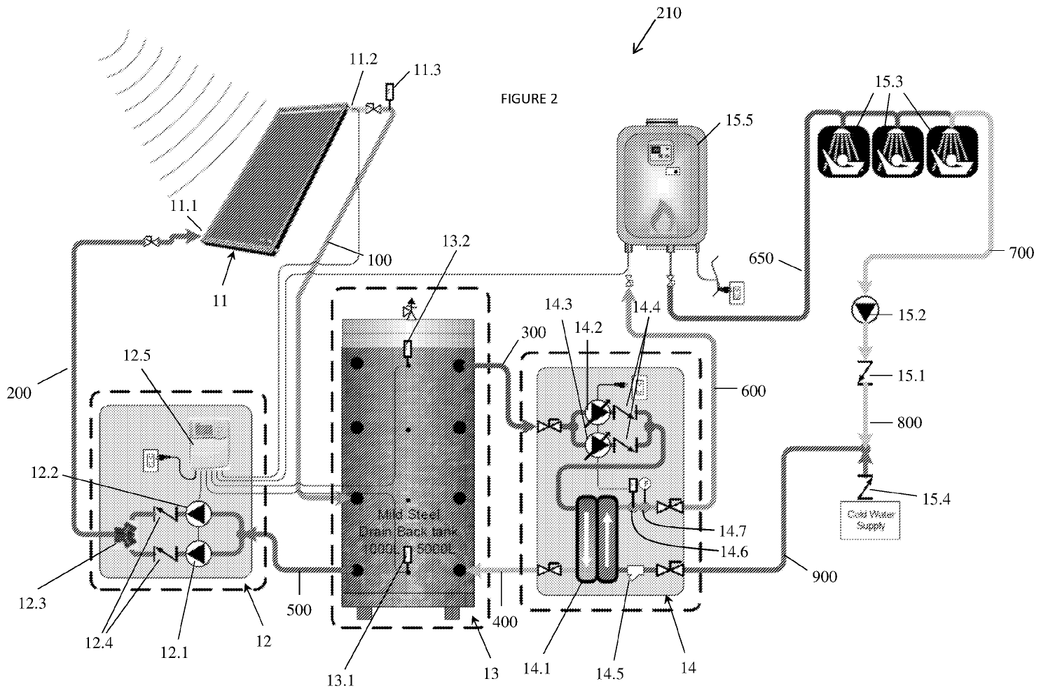

Illustrated in FIG. 2 is a water heating system 210, which is similar to the system 10 of FIG. 1 and like parts and components have been like numbered. The system 210 differs from the system 10, in that system 210 does not include an indirect electric booster element 13.3 as part of the tank 13, but instead a direct booster in the form of a gas water heater 15.5 is located between the outlet of the heat exchanger 14.1 and the end users 15.3, on the end of conduit 600, and connects to the end users 15.3 by intermediate conduit 650. The gas water heater 15.5 takes it signal to begin or cease operating from the solar pump skid 12's main controller 12.5, with potable water being pumped through the secondary circuit 15 and water heater 15.5 by the pump 15.2.

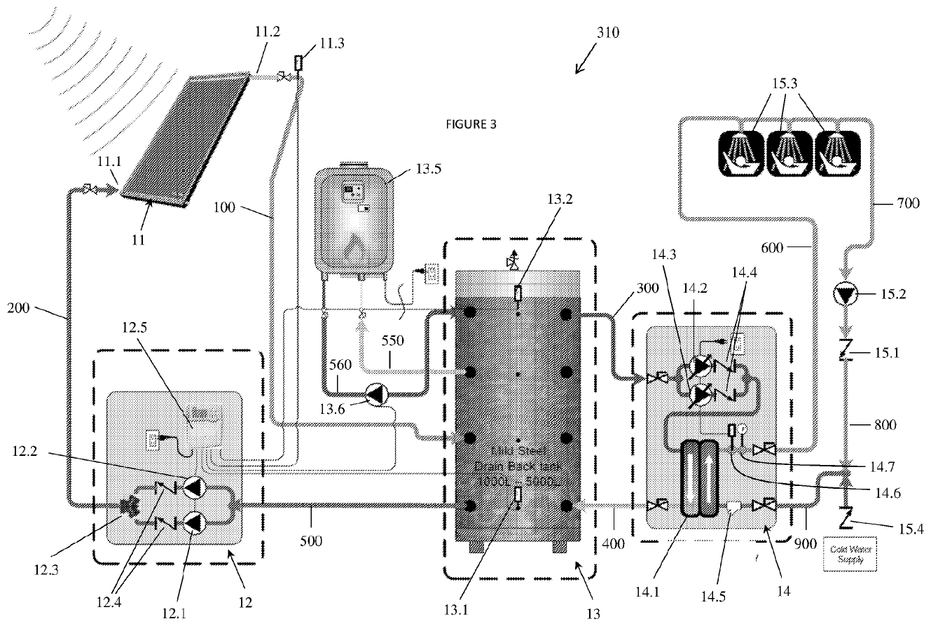

Illustrated in FIG. 3 is a water heating system 310, which is similar to the system 10 of FIG. 1 and like parts and components have been like numbered. The system 310 differs from the system 10, in that system 310 does not include an indirect electric booster element 13.3 as part of the tank 13, but instead a indirect booster in the form of a gas heat transfer fluid heater 13.5 which is located on the end of conduit 550 which takes heat transfer fluid from tank 13 at an intermediate height location on tank 13, and the heat transfer fluid exits heater 13.5 and re-enters the tank 13 at a high location via conduit 560 which has a pump 13.6 controlled by the pump skid 2's main controller 12.5. The gas heat transfer fluid heater 13.5 takes it signal to begin or cease operating from the solar pump skid 12's main controller 12.5.

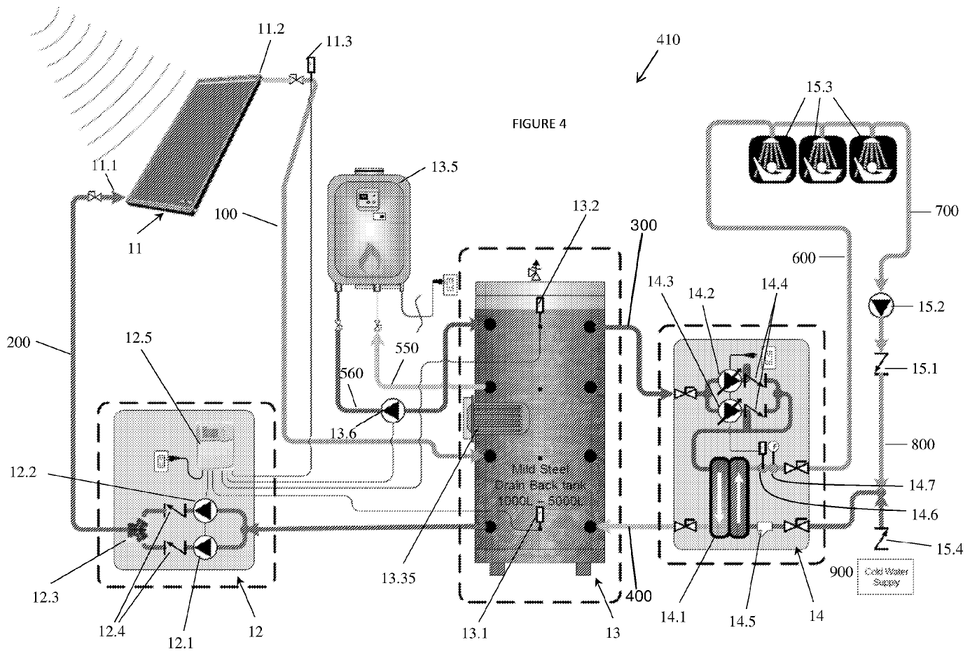

Illustrated in FIG. 4 is a water heating system 410 which is similar to that of system 310 of FIG. 3 and like parts and components have been like numbered. The system 410 differs from the system 310 in that a tank wired and controlled electric heating element 13.35 is present. The system 410 is thus considered a hybrid system as it utilises one or a combination of more than one of the electric element 31.35, solar collector 11 and or gas heater 13.5 to provide the heated transfer fluid in the tank 13. This hybrid system 410 can use energy from any one or more of the solar, gas or electric inputs depending upon time of operation etc., so as to operate the system 410 as cost effectively as is possible with the mixture of three energy sources and the respective tariffs and or costs associated with each.

Illustrated in FIG. 5 is a water heating system 510, which is similar to previous systems in that a heat transfer fluid tank 13 is provided and which interacts with a delivery skid 14 with its heat exchanger 14.1 like in other systems. Like parts and components have been like numbered. The system 510 differs from previous systems in is that the primary circuit is comprised of a co-generation unit 111 which utilises a fuel via intake 111.2 such as natural or coal seam gas, which is burnt in a burner/engine 111.5 with air induced from intake 111.3. The rotary motion from engine 111.5 is used to rotate a generator 111.9, with electricity fed to the building or grid via conductor 111.10. The combustion products from the engine 111.5 are fed, via a catalytic converter 111.4 to a heat recovery heat exchanger 111.6 which heats heat transfer fluid to 80 to 95 degrees C. and which exits the unit by conduit 100 to be delivered to the tank 13. The cooled exhaust gasses exit the system via exhaust 111.8. When the tank has sufficient heated transfer fluid at the desired temperature, as electricity may need to continue to be generated, the excess heated transfer fluid is diverted back along conduit 160 where it is optionally combined with cooled heat transfer fluid from conduit 150, and is fed back to the co-generation unit, or if too hot still, is re-directed via valve 111.11 to conduit 170 then to a chiller unit 111.12, and then back to the co-generation unit 111 via conduit 180 pump 111.7 and conduit 190.

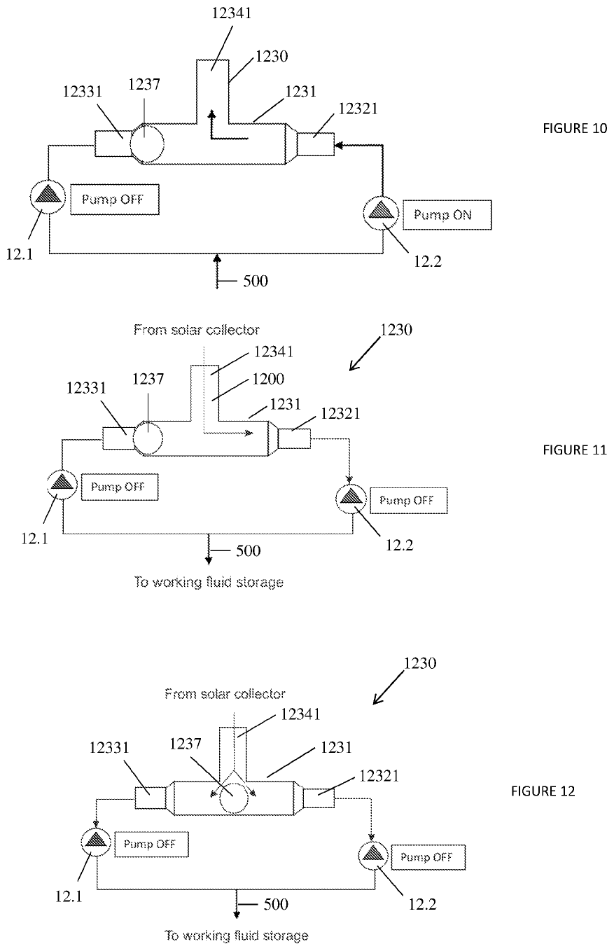

Illustrated in FIGS. 10 to 12 is an alternative valve system 1230 which is schematically illustrated as being plumbed in with pumps 12.1 and 12.2. In the valve system 1230, the flap 12.37 of valve 12.3 of previous figures is replaced by a ball 1237. The valve body 1231 has ports 12331 and 12321 to which the outlets of the pumps 12.1 and 12.2 respectively. The third port 12341 would be connected to the conduit 200 for delivery to, or receiving from, the collector 11. The ball 1237 is preferably of stainless steel I (like flap 12.37) and the body 1231 of valve 120 is preferably of brass or a brass alloy. As illustrated in FIG. 10, when pump 12.2 is on, and pump 12.1 is off, the ball 1237 is pushed by the flow pressure from the pump 12.2 to push against the port 12331 and its seat, thereby preventing a “short circuit” forming and forcing the pumped fluid to exit the valve 1230 via port 12341. If the pump 12.2 is then switched off and pump 12.1 remains off, as in FIG. 11, then when the heat transfer is under gravity or under back pressure caused by overheating in the collector 11 or freezing in the collector 11, then the heat transfer fluid can drain back through the port 12341 and then port 12321 and back through pump 12.2 to the tank 13 via conduit 500. As illustrate din FIG. 12, if the ball 1237 were to occupy an intermediate position then heat transfer fluid can drain back through either or both ports 12331 and 12321 back through the pumps 12.1 and 12.2 and conduit 500 to the tank 13.

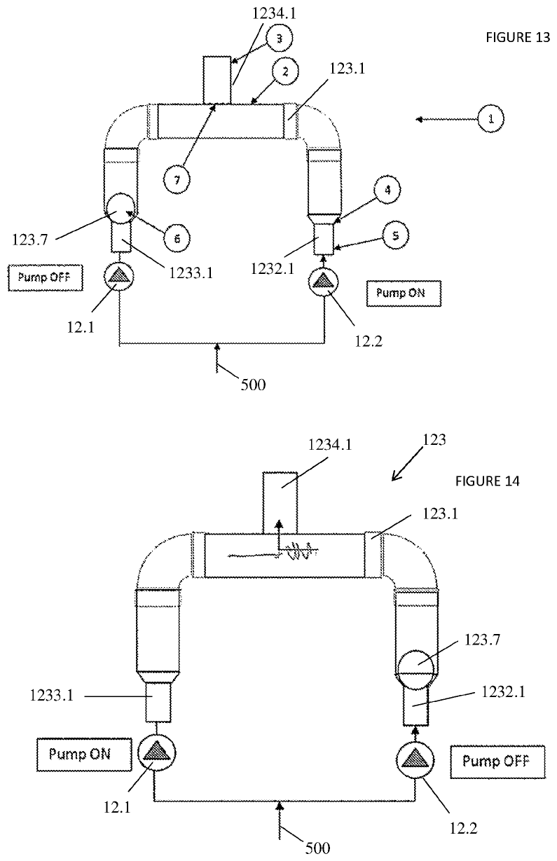

As illustrate din FIGS. 13 and 14, a valve arrangement 123, similar to valve arrangement 1230 is schematically illustrated, in the reversed conditions to FIGS. 10 and 11 above. The main difference between the valve 123 and 1230 is that the valve 123 has its ports 1233.1 and 1232.1 at the end of respective elbows in the valve body 123.1.

The valves 123 and 1230 as described above are illustrated in their respective figures with their third ports 1234.1 and 12341 in a vertical orientation on the page. However, it will be understood that they do not need to be vertical when installed on the pump skid 12, as gravity does not adversely affect or influence the manner of operation of the valves 123 and 1230.

As the units described above are meant for commercial water heating systems such as freshwater stations and or district water systems, the tanks 13 as represented in the FIGS. 1 to 5 are preferably of a mild steel construction and are of a capacity of the order of 1000 to 5000 litres, however any appropriate material can be used such as stainless steel, polymeric materials or composite materials such steel and enamel lined tanks.

Illustrated in FIGS. 15 and 16 is a delivery skid 14, which has a base 14.85 and upper structure 14.75 assembled thereon, which allows for the mounting of two heat exchangers 14.1 which are connected in parallel to the hot water supply conduit 600.1 at one end and to the ring main return and cold water supply entry conduit 900.1 at the other end. Each heat exchanger 14.1 connects in parallel to the conduits 600.1 and 900.1 via a respective isolation valve 14.95. This allows the respective heat exchange 14.1 to be removed, replaced or repaired in the event of a failure, by simply closing isolation valve 14.95 related to the heat exchanger to be repaired or replaced, while at the same time opening the valves 14.95 on the adjacent heat exchanger. Having this redundancy in the delivery skid 14 ensures that there is no disruption to the supply of heated water to the end users when a heat exchanger 14.1 needs to go offline.

The conduits 600.1 and 900.1 each have respective flange 600.11 and 900.11 at their respective ends, which as will be described later allow for the connection to a like flange on an adjacent like delivery skid 14. One flange end 600.11 and 900.1 will be blanked off by a flanged plate or cap 600.2 and 900.2, which thereby seals that end, in the case where a single skid 14 is employed in a system. The modular nature of the delivery skid 14 allows users to connect up as many as needed for the hot water outputs required.

Also mounted on the base 14.85 and structure 14.75 are two pumps 14.2 and 14.3 and respective isolation valves 14.95, and there are also check valves, filters sensors/senders, and temperature cut outs (item numbers 14.4, 14.5, 14.6, 14.7 in FIGS. 1 to 5) which are not visible in FIG. 15 or 16.

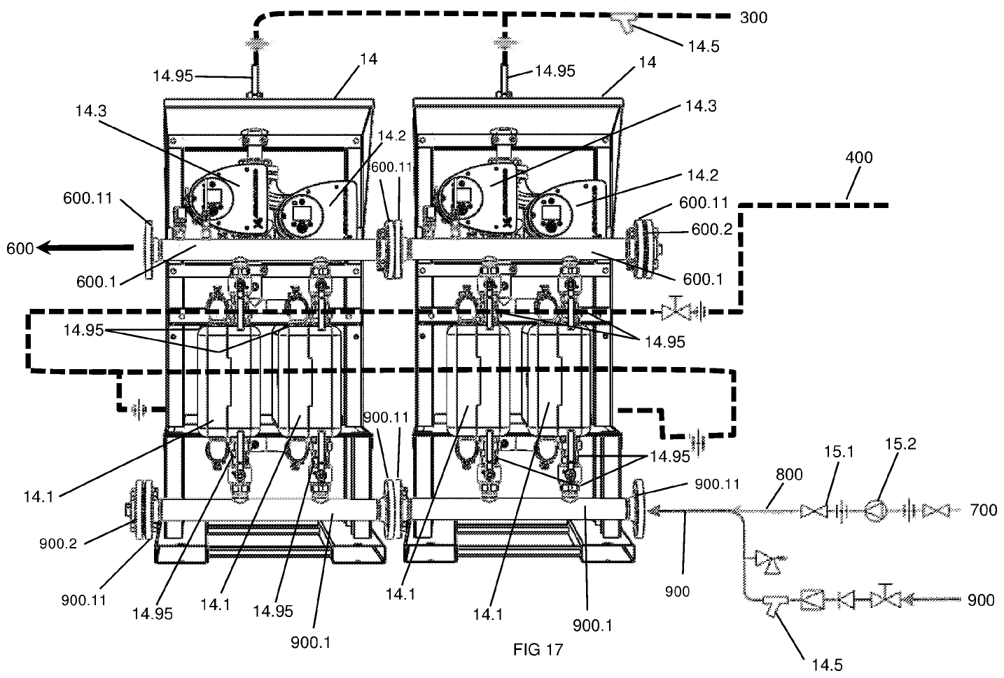

As illustrated in FIG. 17, two such delivery skids 14 are assembled side by side, where one flanged plate 600.2 is used to close off one end of the conduits 600.1, and the flanged plated 900.2 to close off one end of the conduits 900.1. The number of skids 14 which would be connected together to provide the assembly of delivery skids will be dependent upon the size of the system, the numbers of outlets and demand for hot water in the buildings and or complexes where the water heating systems will be installed.

As can be seen from FIG. 17, the primary flow of heat transfer fluid, the heat transfer fluid path being shown in broken line, passes into the skid 14 via the conduit 300, as in the other systems described above, which has an inline filter 14.5 and this path is split so as to enter each skid 14. This then passes to the pumps 14.2 and 14.3 as described above then to a respective the heat exchanger 14.1 (or both depending upon needs) then exits the skid 14 back to the tank 13 via the conduit 400.

The systems described above utilise a heat exchanger 14.1 and pumps 14.2,14.3 to transfer energy in fluids to potable water at a user adjustable set point. Fluid that is heated by any means such as electric, gas, cogeneration systems, solar systems, heat pumps etc is forced through heat exchangers 14.1 by pump 14.2, 14.3. The pumps 14.2, 14.3 receive an electrical control signal from a temperature sensing device 14.6 (and cut off 14.7). By using a proportional integral derivative controller, the pump compares this control signal to its set point and the motors speed is altered accordingly. If the temperature detected is below the set point, the pump speeds up so as to flow more fluid through the heat exchangers 14.1. The effect of this higher fluid flow is a greater exchange of energy and therefore an increase in the temperature of the potable water exiting the system and being delivered to end users. Conversely if the energy required by the secondary side to maintain a set temperature falls, the flow of fluid in the primary side controlled by the pump also falls.

The temperature of the heat transfer fluid contained in a storage tank 13 (see FIGS. 1 to 5) will rise and fall depending on its inputs and outputs, for example an electric storage water heater's temperature will rise when it is heated by an immersion element and fall due to heat loss to the surroundings. The effect of a fall in the primary side temperature will be a reduction in the amount of energy exchanged with the secondary side. This results in a fall in temperature on the secondary side. The pump reacts to this fall in temperature by increasing pump speed accordingly.

Flow rates on the secondary side will vary with user input.

The system can cope with very large fluctuations in temperature and flow either separately or simultaneously without altering the method of control.

The separation of fluid streams enables greater flexibility as the fluids need not be compatible with each other, for example cogeneration systems using oil additives as the heating medium coupled with potable water.

Due to the arrangement of components, the pressure drop across the system is very low which enables the use of highly efficiency pumps operating with very low energy input.

Upon failure of any sensing mechanism the systems will cease the flow of fluid thus preventing any further exchange of heat. As such the systems have a fail safe feature.

The systems do not require the addition of expensive valves instead utilise a more intelligent version of a pump.

A solar system using heat transfer fluid on one side of the heat exchanger and potable water on the other is preferred, however it will be readily understood that utilising alternative fluids, or even potable fluids, on both sides is an alternative.

The pumps 14.2 and 14.3 can be provided as either single headed or dual headed versions to provide duty standby.

Illustrated in the FIGS. 1 to 5 are isolation valves which are represented by the symbol

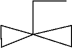

and by item number 14.95 in FIGS. 15 to 17, and symbol

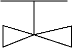

in FIG. 17. Such isolation valves generally appear at entries and exits to components, where conduits are to be connected, and they allow for the closing of such valves to assist in the removal and installation of components.

While the above description and embodiments are directed to potable water systems, it will be readily understood that this invention and these systems and components are able to be utilised with respect to the heating of other liquids other than potable water, such as milk processing plants and the like.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1-24. (canceled)

25. A solar water heating system comprising:
a tank configured to store heat transfer fluid;
a solar collector in fluid communication with the tank; and
a pump system in fluid communication with the tank and the solar collector, the pump system including:
a first pump having a first inlet and a first outlet;
a second pump having a second inlet and a second outlet; and
a valve assembly in communication with the first outlet and the second outlet, the valve assembly configured to direct the heat transfer fluid from the first outlet to the solar collector when the first pump is operating and to direct the heat transfer fluid from the second outlet to the solar collector when the second pump is operating.

26. The solar water heating system of claim 25, wherein the first pump and the second pump are arranged in parallel.

27. The solar water heating system of claim 25, wherein in response to the second pump not operating, the first pump is configured to operate and in response to the first pump not operating, the second pump is configured to operate.

28. The solar water heating system of claim 25, wherein in response to the first pump and the second pump not operating, the first pump and the second pump are configured to transfer the heat transfer fluid from the solar collector to the tank.

29. The solar water heating system of claim 25, wherein the pump system is provided as part of a first skid.

30. The solar water heating system of claim 25, wherein the heat transfer fluid is non-potable water.

31. The solar water heating system of claim 25, wherein the heat transfer fluid is potable water.

32. The solar water heating system of claim 25, wherein the solar collector includes one or more temperature sensors.

33. The solar water heating system of claim 25, wherein the tank includes one or more temperature sensors.

34. The solar water heating system of claim 25, wherein the valve assembly includes:
a body;
a first port configured to connect to the first outlet of the first pump;
a second port configured to connect to the second outlet of the second pump; and
a third port configured to operate as an outlet when the first pump or the second pump is operating and configured to operate as an inlet when the first pump and the second pump are not operating.

35. The solar water heating system of claim 34, wherein in response to the first pump and the second pump are not operating, the heat transfer fluid is directed from the solar collector to the tank via the third port.

36. The solar water heating system of claim 34, wherein the valve assembly further comprises a valve member disposed between the first port and the second port, the valve member configured to close the first port in response to the second pump operating and configured to close the second port in response to the first pump operating.

37. The solar water heating system of claim 36, wherein the valve member is a flap hingedly connected to the body.

38. The solar water heating system of claim 37, wherein the flap includes a pivot tube configured to rotatably or pivotally hold the flap in the body.

39. The solar water heating system of claim 36, wherein the valve member is a ball.

40. The solar water heating system of claim 39, wherein in response to the ball being disposed at an intermediate position between the first port and the second port and the first pump and the second pump not operating, the heat transfer fluid is directed from the solar collector to the tank via the first port and the second port.

41. The solar water heating system of claim 25, further comprising a controller, the controller configured to:
receive temperature signals from one or more temperature sensors; and
output instructions to selectively activate a supplemental heat source to boost a temperature of the heat transfer fluid.

42. The solar water heating system of claim 41, wherein the supplemental heat source is an electric heating element disposed within the tank.

43. The solar water heating system of claim 25, further comprising a second skid including a heat exchanger containing potable water, the heat exchanger configured to receive the heat transfer fluid from the tank and heat the potable water.

44. The solar water heating system of claim 43, wherein the heat exchanger is further configured to direct heated potable water from the second skid to an end user.
